(19) United States
(12) Patent Application Publication
(10) Pub. No.: US 2026/0064655 A1
(43) Pub. Date: Mar. 5, 2026

(54) OPERATION EXECUTION WITH AUTOMATICALLY UPDATED PROFILE DATA STRUCTURES USING MACHINE LEARNING

(71) Applicant: ADP, Inc., Roseland, NJ (US)

(72) Inventors: Natalie Krisina La Spisa, Florham Park, NJ (US); Nilesh Patel, Florham Park, NJ (US); Stephen Edward Overton, Florham Park, NJ (US); Stella Jia, Florham Park, NJ (US); Monica Bansal, Florham Park, NJ (US); Isabella Cabanellos Masiero, Roseland, NJ (US); Madison Amelia Korteling, Florham Park, NJ (US); Karen E. De Jong, Florham Park, NJ (US); Eslin M. Eckert, Florham Park, NJ (US); Christopher Martin, Cambridgeshire (GB)

(73) Assignee: ADP, Inc., Roseland, NJ (US)

(21) Appl. No.: 19/311,618

(22) Filed: Aug. 27, 2025

Related U.S. Application Data
(60) Provisional application No. 63/688,155, filed on Aug. 28, 2024.

(51) Int. Cl. G06F 16/23; G06F 16/353

(52) U.S. Cl. CPC G06F 16/23; G06F 16/353

(57) ABSTRACT

A system can receive one or more documents. The system can determine, for a document, using a machine learning model, a classification of a type of the document and a confidence score associated with the classification, where the confidence score indicates a level of performance with which the machine learning model outputs the classification of the type of the document. For the document, the system can select a data extraction engine based on the confidence score, where the data extraction engine extracts data points from the document. The system can prioritize the extracted data points based on the confidence score associated with the document. The system can update a profile data structure in response to aggregating the prioritized extracted data points. The system can input the profile data structure into a payroll processing system to execute an operation in accordance with the updated profile data structure.

### CROSS-REFERENCE TO RELATED APPLICATIONS

This application claims the benefit of and priority under 35 U.S.C. § 119 to U.S. Provisional Application No. 63/688,155, filed Aug. 28, 2024, the entirety of which is hereby incorporated by reference herein.

### TECHNICAL FIELD

This application is generally related to data management and processing, and more particularly, to operation execution with automatically updated profile data structures using machine learning.

### BACKGROUND

Data management and processing technologies can facilitate the efficient handling, transformation, and analysis of diverse datasets. The complexity and size of the datasets managed by such systems support robust operations and execution. As datasets and operational environments have become more dynamic, these systems have been refined to manage data efficiently and improve system performance.

### SUMMARY

Aspects of technical solutions described herein can be directed to a computing architecture configured for efficient operation execution. For example, aspects of the technical solutions can implement machine learning techniques to extract data from documents and automatically update profile data structures. Data extraction from documents can be technically challenging due to the nuanced formats and structures they present. These challenges can significantly impact the efficiency, accuracy, and scalability of data processing operations, especially when processing unstructured documents that lack a predefined data model or structure.

The technical solutions described herein can automate the data extraction process and implement a cloud-based computing infrastructure to manage substantial volumes of documents. The computing infrastructure can execute machine learning models trained on vast datasets of predefined categories associated with diverse document formats. The machine learning models can provide accurate identification and extraction of relevant information from both structured and unstructured documents. The technical solutions described herein can dynamically select a machine learning model for each document based on document type. By executing a wide range of machine learning techniques, including large language models, optical character recognition, and other context-aware algorithms, the technical solutions can effectively interpret and process different types of documents and their formats.

The computing architecture of the technical solutions described herein can be configured for parallel processing of large volumes of documents and data extraction tasks using distributed computing architectures or cloud platforms. The computing architecture can consolidate extracted data from various sources into a unified format, independent of the original document structure, to streamline data analysis and integration with subsequent systems. Additionally, the computing architecture can prioritize the extracted data points based on confidence scores generated during document classification and data extraction. For example, the computing architecture can assign higher priority to documents with higher confidence scores to ensure that high-quality data is processed first.

Furthermore, the computing architecture can normalize the output for each profile data structure based on the source and associated confidence scores to preserve data consistency and facilitate subsequent analysis. The computing architecture can integrate prioritized extracted data into corresponding profile data structures and update these data structures incrementally to maintain the latest information. For example, the technical solutions can include identifying the profile based on extracted data attributes (e.g., entity identifiers), merging extracted data with existing profile information, and validating data integrity. Thus, technical solutions provide operation execution with automatically updated profile data structures using machine learning.

At least one aspect is directed to a system. The system can include one or more processors, coupled with memory. The system can determine, using a machine learning model trained on a dataset of predefined categories maintained in a database, for a document: a classification of a type of the document and a confidence score associated with the classification. The confidence score can indicate a level of performance with which the machine learning model outputs the classification of the type of the document. The system can select, for the document, a data extraction engine based on the confidence score. The data extraction engine can be configured to extract data points from the document. The system can prioritize the extracted data points based on the confidence score associated with the document. The system can update a profile data structure in response to aggregating the prioritized extracted data points. The system can input the profile data structure into a payroll processing system to cause the payroll processing system to execute one or more operations in accordance with the updated profile data structure.

The system can receive the document in a batch upload. The system can classify the document based on a document file type. The document file type can include at least one of a portable document format, a word processing document, a spreadsheet document, a photographic experts group image, a portable network graphics image, or a tagged image file format image. The type of the document can include at least one of a report, a tax form, a handwritten note, a handwritten number, an invoice, a receipt, a contract, or an email. The system can determine, via the machine learning model, the confidence score for indicating a level of accuracy with which data is extracted from the document. The system can prioritize the extracted data point based on: a combination of the confidence score associated with the classification of the document and the confidence score associated with the extracted data point, and a determination that the combined confidence score satisfies a predefined threshold. The dataset of predefined categories can include a plurality of field-value pairs. Each field-value pair can correspond to an attribute associated with training the machine learning model.

The system can determine that a confidence score associated with the classification of a second document is below a predefined threshold. The system can select, responsive to determining that the confidence score is below the predefined threshold, a plurality of data extraction engines to extract data points from the second document. The system can aggregate the extracted data points from the plurality of data extraction engines to generate a set of extracted data points to be used for updating the profile data structure. The system can determine that a confidence score associated with the classification of a second document is below a predefined threshold. The system can reject, responsive to determining that the confidence score is below the predefined threshold, processing of the second document. The system can transmit a notification to a client device to cause the client device to provide a modified version of the second document.

At least one aspect is directed to a method. The method can include determining, using a machine learning model trained on a dataset of predefined categories maintained in a database, for a document: a classification of a type of the document and a confidence score associated with the classification. The confidence score can indicate a level of performance with which the machine learning model outputs the classification of the type of the document. The method can include selecting, for the document, a data extraction engine based on the confidence score. The data extraction engine can be configured to extract data points from the document. The method can include prioritizing the extracted data points based on the confidence score associated with the document. The method can include updating a profile data structure in response to aggregating the prioritized extracted data points. The method can include providing the updated profile data structure to a payroll processing system to cause the payroll processing system to execute one or more operations in accordance with the updated profile data structure.

The method can include receiving the document in a batch upload. The method can include classifying the document based on a document file type. The document file type can include at least one of a portable document format, a word processing document, a spreadsheet document, a photographic experts group image, a portable network graphics image, or a tagged image file format image. The type of the document can include at least one of a report, a tax form, a hand-written note, a hand-written number, an invoice, a receipt, a contract, or an email. The method can include determining, via the machine learning model, the confidence score for indicating a level of accuracy with which data is extracted from the document. The method can include prioritizing the extracted data point based on: a combination of the confidence score associated with the classification of the document and the confidence score associated with the extracted data point, and a determination that the combined confidence score satisfies a predefined threshold. The dataset of predefined categories can include a plurality of field-value pairs, each field-value pair corresponding to an attribute associated with training the machine learning model.

At least one aspect is directed to a non-transitory computer readable medium, including one or more instructions stored thereon and executable by a processor. The processor can determine, using a machine learning model trained on a dataset of predefined categories maintained in a database, for a document: a classification of a type of the document and a confidence score associated with the classification. The confidence score can indicate a level of performance with which the machine learning model outputs the classification of the type of the document. The processor can select, for the document, a data extraction engine based on the confidence score. The data extraction engine can be configured to extract data points from the document. The processor can prioritize the extracted data points based on the confidence score associated with the document. The processor can update a profile data structure in response to aggregating the prioritized extracted data points. The processor can input the profile data structure into a payroll processing system to cause the payroll processing system to execute one or more operations in accordance with the updated profile data structure.

### BRIEF DESCRIPTION OF THE DRAWINGS

These and other aspects and features of the present implementations are depicted by way of example in the figures discussed herein. Present implementations can be directed to, but are not limited to, examples depicted in the figures discussed herein. Thus, the technical solutions described herein are not limited to any figure or portion thereof depicted or referenced herein, or any aspect described herein with respect to any figures depicted or referenced herein.

FIG. 1 depicts an example system to provide operation execution with automatically updated profile data structures using machine learning, in accordance with some implementations.

FIG. 2 depicts an example operation of a system to provide operation execution with automatically updated profile data structures using machine learning, in accordance with some implementations.

FIG. 3 depicts an example method of operation execution with automatically updated profile data structures using machine learning, in accordance with some implementations.

FIG. 4 depicts a block diagram of an example computing system for implementing the embodiments of the present solution, including, for example, the systems depicted in FIGS. 1-2, and the method depicted in FIG. 3.

### DETAILED DESCRIPTION

Aspects of the technical solutions are described herein with reference to the figures, which are illustrative examples of this technical solution. The figures and examples below are not meant to limit the scope of the technical solutions to the present implementations or to a single implementation, and other implementations in accordance with present implementations are possible, for example, by way of interchange of some or all of the described or illustrated elements. Where certain elements of the present implementations can be partially or fully implemented using known components, only those portions of such known components that are necessary for an understanding of the present implementations are described, and detailed descriptions of other portions of such known components are omitted to not obscure the present implementations. Terms in the specification and claims are to be ascribed no uncommon or special meaning unless explicitly set forth herein. Further, the technical solutions and the present implementations encompass present and future known equivalents to the known components referred to herein by way of description, illustration, or example.

Aspects of the technical solutions described herein achieve operation execution with automatically updated profile data structures using machine learning. For example, the technical solutions can use a system architecture that can receive documents and use a machine learning model, trained on a database of predefined categories, to classify each document with a corresponding confidence score. Based on the confidence score, the system can select a data extraction engine to extract data points from the classified documents. The extracted data points can be prioritized according to the associated confidence scores and aggregated to update a profile data structure. The system can provide the updated profile data structure to a payroll processing system to trigger specific operations.

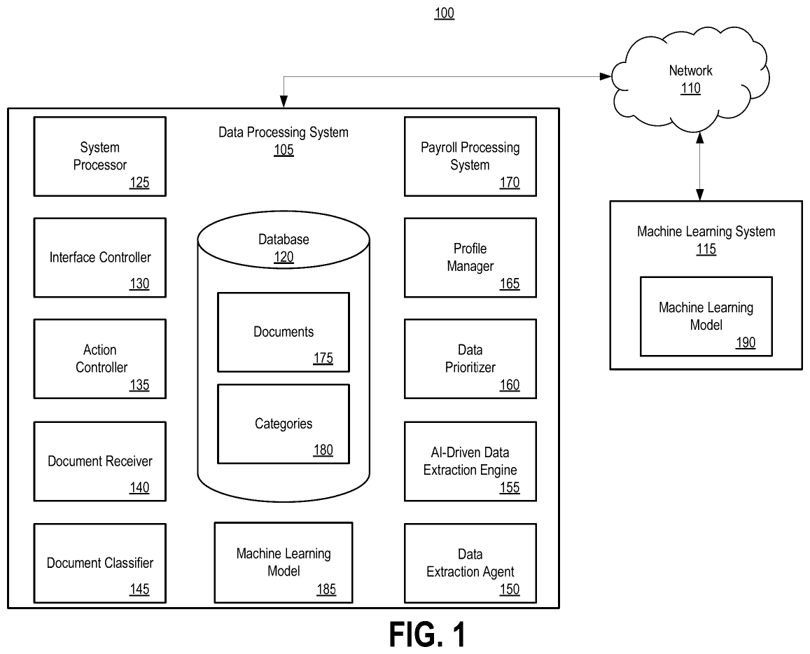

FIG. 1 depicts an example system according to one or more aspects of the technical solutions described herein. As illustrated by way of example in FIG. 1, a system 100 can include one or more components, such as a data processing system 105 and a machine learning system 115. One or more components of the system 100 can communicate via network 110.

The data processing system 105 can include a physical computer system operatively coupled or couplable with one or more components of the system 100. The data processing system 105 can include a cloud system, a server, a distributed remote system, or any combination thereof. The data processing system 105 can include a virtual computing system, an operating system, and a communication bus to effect communication and processing. The data processing system 105 can include physical infrastructure, such as physical servers, storage devices, and network equipment housed in data centers. The data processing system 105 can include a virtual computing system, which can include cloud-based virtual machines or containers for running applications and services. The data processing system 105 can include an operating system that can function as the core manager, allocating resources, configuring processes, and maintaining seamless interaction between hardware and applications. The data processing system 105 can include a communication bus that can facilitate communication between different components within the system. The data processing system 105 can be configured to connect with external systems to allow for data exchange and service delivery to end users.

The network 110 can include any type or form of network. The geographical scope of the network 110 can vary widely, and the network 110 can include a body area network (BAN), a personal area network (PAN), a local-area network (LAN), e.g., Intranet, a metropolitan area network (MAN), a wide area network (WAN), or the Internet. The topology of the network 110 can be of any form and can include, e.g., any of the following: point-to-point, bus, star, ring, mesh, or tree. The network 110 can include an overlay network which is virtual and sits on top of one or more layers of other networks 110. The network 110 can be of any such network topology as known to those ordinarily skilled in the art capable of supporting the operations described herein. The network 110 can utilize different techniques and layers or stacks of protocols, including, e.g., the Ethernet protocol, the Internet protocol suite (TCP or IP), the ATM (Asynchronous Transfer Mode) technique, the SONET (Synchronous Optical Networking) protocol, or the SD (Synchronous Digital Hierarchy) protocol. The TCP or IP Internet protocol suite can include application layer, transport layer, Internet layer (including, e.g., IPv6), or the link layer. The network 110 can include a type of a broadcast network, a telecommunications network, a data communication network, or a computer network.

The machine learning system 115 can include a cloud system, a server, a distributed remote system, or any combination thereof. The machine learning system 115 can include, but is not limited to, at least, central processing unit (CPU), graphics processing unit (GPU), tensor processing units (TPUs), or the like. The machine learning system 115 can include a memory operable to store one or more instructions for operating components of the machine learning system 115 and operating components operably coupled to the machine learning system 115. The machine learning system 115 can be internal to the data processing system 105. The machine learning system 115 can exist external to the data processing system 105 and can be accessed via the network 110.

The machine learning system 115 can include various machine learning models 190. The machine learning models 190 can be trained with same or different types of machine learning techniques, trained with the same or different types of training data, or trained or configured to receive different types of input or provide different types of output. Example machine learning techniques can include neural networks, such as a generative adversarial network (e.g., a generator neural network and a discriminator neural network that are trained simultaneously through adversarial training), a variational autoencoder (e.g., an autoencoder neural network that learns to generate new data samples by modeling the underlying probability distribution of the data), an autoregressive model, or other types of neural networks (e.g., deep learning models, convolution neural networks, recurrent neural networks, or transformers). Transformers can refer to or include a type of deep learning model architecture configured for natural language processing, including, for example, bidirectional encoder representations (“BERT”), generative pre-trained transformers, text-to-text transformer, transformer-XL, robustly optimized BERT, or distilled BERT. Other types of machine learning techniques can include supervised learning models, unsupervised learning models, semi-supervised learning models, or reinforcement learning models.

For example, a supervised machine learning technique can include a support vector machine (SVM) used for classification and regression tasks. Given a set of labeled training data, a support vector machine can identify the hyperplane that separates the data into classes with the largest possible margin (e.g., distance between the hyperplane and nearest data points from each class). For example, the data processing system 105, via the machine learning system 115, can implement the SVM to classify the type of the document 175 based on a set of features derived from the content and structure of the document 175, such as specific keywords, fonts, and formatting. Such a configuration can minimize computational resources for training and classification. The SVM can operate on a limited number of well-defined features to allow the data processing system 105 to classify documents 175 with high accuracy and speed. Based on the machine learning models 190 described herein, the data processing system 105 can process a high volume of diverse types of documents 175.

The machine learning model 190 can be deployed within the data processing system 105 (as indicated by machine learning model 185) or externally as remote services. The machine learning model 185, residing within the data processing system 105, can be similar to, and include any of the structure and functionality of, the machine learning model 190.

The data processing system 105 can include, interface with, communicate with, or otherwise utilize a database 120. The database 120 can be a computer-readable memory that can store or maintain any of the information described herein. The database 120 can store data associated with the system 100. The database 120 can include one or more hardware memory devices to store binary data, digital data, or the like. The database 120 can include one or more electrical components, electronic components, programmable electronic components, reprogrammable electronic components, integrated circuits, semiconductor devices, flip flops, arithmetic units, or the like. The database 120 can include at least one of a non-volatile memory device, a solid-state memory device, a flash memory device, or a NAND memory device. The database 120 can include one or more addressable memory regions disposed on one or more physical memory arrays. A physical memory array can include a NAND gate array disposed on, for example, at least one of a particular semiconductor device, an integrated circuit device, or a printed circuit board device. In an aspect, the database 120 can correspond to a non-transitory computer readable medium. In an aspect, the non-transitory computer readable medium can include one or more instructions executable by a system processor 125.

The database 120 can store or maintain one or more data structures, which can include containers (such as tables, arrays, or linked lists), indices, or otherwise store each of the values, pluralities, sets, variables, vectors, numbers, or thresholds described herein. The database 120 can be accessed using one or more memory addresses, index values, or identifiers of any item, structure, or region maintained in the database 120. The database 120 can be accessed by the components of the data processing system 105, the machine learning system 115, or any other computing device described herein, via the network 110. The database 120 can be internal to the data processing system 105. The database 120 can exist external to the data processing system 105 and can be accessed via the network 110. For example, the database 120 can be distributed across many different computer systems (e.g., a cloud computing system) or storage elements and may be accessed via the network 110 or a suitable computer bus interface.

The database 120 can store or maintain documents 175 in various formats, such as text, image, audio, video, or any combination thereof. The documents 175 can include a wide range of content, including, but not limited to, reports, presentations, emails, contracts, financial data, and multimedia content. The documents 175 can include structured documents such as tax reports (e.g., federal income tax, social security, Medicare taxes, etc.), carnings reports (e.g., summaries of total earnings, hours worked, net pay, etc.), and tax filings (e.g., IRS forms for annual wage, tax statements, etc.). The documents 175 can include unstructured documents such as notes (e.g., varied structured handwritten or typed notes), and queries (e.g., informal documents such as letters or messages). The database 120 can organize and manage the documents 175 through metadata, tags, or other indexing mechanisms. The database 120 can implement version control. The database 120 can incorporate security measures to protect sensitive document information, such as encryption, access controls, and audit trails, among others.

The database 120 can organize the documents 175 into different categories 180 based on document types, file types, labels, and other classification schemes. The document types can refer to the nature of the content within the documents 175, such as reports, emails, or contracts, among others. The file types can specify the digital format (e.g., PDF, DOCX, etc.) of the documents 175 stored. The database 120 can function as a lookup table, associating documents 175 with predefined categories 180. The database can associate each document 175 with one or more relevant categories based on predefined criteria. For example, a document with a “.pdf” file extension and content related to financial reports can be assigned to “Financial Documents.”

The dataset of categories 180 can include a plurality of field-value pairs. Each field-value pair can correspond to an attribute associated with training the machine learning model. The field-value pairs can define the characteristics of each category 180, such as document type, file type, keywords, or other relevant attributes. The categories 180 can be implemented as a structured table or matrix, where each row can correspond to a category and each column can indicate an attribute. The attributes within the dataset of categories 180 can be of various data types, including categorical (which corresponds to distinct categories or groups), textual (which corresponds to textual information), and numerical (which corresponds to quantitative values). Additional metadata can be associated with each category 180 to provide further context, such as category name, category description, creation date, and last modified date, among others.

The data processing system 105 can store, in one or more regions of the memory of the data processing system 105, or in the database 120, the results of any or all computations, determinations, selections, identifications, generations, constructions, or calculations in one or more data structures indexed or identified with appropriate values. Any or all values stored in the database 120 can be accessed by any computing device described herein, such as the data processing system 105, to perform any of the functionalities or functions described herein. In implementations where the database 120 forms a part of a cloud computing system, the database 120 can be a distributed storage medium in a cloud computing system and can be accessed by any of the components of the data processing system 105, by the machine learning system 115, or by any other computing devices described herein.

The data processing system 105 can include, interface with, communicate with, or otherwise utilize a system processor 125. The system processor 125 can be or include any script, file, program, application, set of instructions, or computer-executable code that can be configured to execute one or more instructions associated with the data processing system 105. The system processor 125 can include an electronic processor, an integrated circuit, or the like, including one or more of digital logic, analog logic, digital sensors, analog sensors, communication buses, volatile memory, nonvolatile memory, and the like. The system processor 125 can include, but is not limited to, at least one microcontroller unit (MCU), microprocessor unit (MPU), central processing unit (CPU), graphics processing unit (GPU), physics processing unit (PPU), embedded controller (EC), or the like. The system processor 125 can include a memory operable to store one or more instructions for operating components of the system processor 125 and operating components operably coupled to the system processor 125. For example, the one or more instructions can include one or more of firmware, software, hardware, operating systems, or embedded operating systems. The system processor 125 or the data processing system 105 generally can include one or more communication bus controllers to effect communication between the system processor 125 and the other elements of the data processing system 105.

The data processing system 105 can include, interface with, communicate with, or otherwise utilize an interface controller 130. The interface controller 130 can be or include any script, file, program, application, set of instructions, or computer-executable code that can be configured to link the data processing system 105 with one or more of the network 110 and the machine learning system 115 using one or more communication interfaces. A communication interface can include, for example, an application programming interface (“API”) compatible with a particular component of the data processing system 105 or the machine learning system 115. The communication interface can provide a particular communication protocol compatible with a particular component of the data processing system 105 and a particular component of the machine learning system 115. The interface controller 130 can be compatible with particular content objects and can be compatible with particular content delivery systems corresponding to particular content objects, structures of data, types of data, or any combination thereof. For example, the interface controller 130 can be compatible with the transmission of structured or unstructured data according to one or more metrics or data of the machine learning system 115.

The data processing system 105 can include, interface with, communicate with, or otherwise utilize an action controller 135. The action controller 135 can be or include any script, file, program, application, set of instructions, or computer-executable code that can be configured to manage and execute actions associated with one or more components of the data processing system 105. The action controller 135 can define and manage workflows comprised of multiple interconnected tasks. The action controller 135 can initiate, monitor, and control the execution of workflow steps. The action controller 135 can implement conditional logic for dynamic workflow routing. The action controller 135 can execute multiple tasks concurrently through parallel processing. The action controller 135 can implement error handling and recovery mechanisms for workflow exceptions. The action controller 135 can track workflow progress and provide status updates. For example, the action controller 135 can include one or more interfaces to detect input at various portions of a workflow and can provide output responsive to specific portions of a workflow.

The data processing system can include, interface with, communicate with, or otherwise utilize a document receiver 140. The document receiver 140 can be or include any script, file, program, application, set of instructions, or computer-executable code that is configured to receive documents 175. The document 175 can be a digital representation of information stored in a structured or unstructured format. The document receiver 140 can receive documents 175 from various sources, including, but not limited to, emails, web portals, file uploads, application programming interfaces (APIs), or direct system-to-system transfers. The document receiver 140 can receive multiple documents 175 simultaneously in batch mode. The document receiver 140 can verify the file format and structure of incoming documents 175. The document receiver 140 can transmit confirmation messages to document senders upon successful receipt. The document receiver 140 can identify and report errors or inconsistencies in incoming documents 175. The document receiver 140 can transmit the received documents 175 to subsequent components within the data processing system 105.

The data processing system 105 can include, interface with, communicate with, or otherwise utilize a document classifier 145. The document classifier 145 can be or include any script, file, program, application, set of instructions, or computer-executable code that can be configured to classify documents. In an aspect, the document classifier 145 can include any combination of hardware, software, or machine learning models (or a generative artificial intelligence (AI) model, such as a large language model (LLM), a transformer neural network, etc.). In an aspect, the document classifier 145 can cause the machine learning model 185, via the action controller 135, to classify the documents 175. In an aspect, the document classifier 145 can cause the machine learning system 115, via the data processing system 105, to execute the machine learning model 190 to classify the documents 175.

The document classifier 145, or any of the machine learning models, can be trained on the predefined categories 180 maintained in the database 120. For example, the document classifier 145, or any of the machine learning models, can be trained with a dataset of labeled documents 175, where each document 175 can be associated with one or more predefined categories. The document classifier 145, or any of the machine learning models, can be trained on a diverse dataset that includes various document types, formats, and content structures. The document classifier 145 can identify patterns and features within the documents 175 that correlate with predefined categories. The document classifier 145 can learn to identify specific characteristics of the documents 175, such as word frequency, syntax, or semantic content, that are indicative of particular categories. The document classifier 145 can classify previously unencountered documents 175 into categories based on the learned patterns. For example, the document classifier 145, or any of the machine learning models, can compare the features of an unencountered document 175 to the patterns identified during training, determining the category with the closest match to assign it to the document 175. In an aspect, the data processing system 105 can enhance the performance of the document classifier 145 by using machine learning techniques such as transfer learning. For example, machine learning models, such as the machine learning model 190 executed by the machine learning system 115, can be used to fine-tune the document classifier 145 or any other machine learning model.

The document classifier 145 can determine a type of the document 175 for each received document 175. The type of the document 175 can be a categorical label determined for the document 175 based on its content, format, and structure, among others. The document classifier 145 can identify potential types of the document 175 from a predefined taxonomy, including, but not limited to, reports, tax forms, handwritten notes, handwritten numbers, invoices, receipts, contracts, and emails. The document classifier 145 can use pattern recognition, machine learning, natural language processing techniques, optical character recognition, and other context-aware algorithms to determine the type of the document 175. The document classifier 145 can classify documents 175 based on the file format or the document file type. The file format can be determined by the file extension or header information associated with the document 175. The file formats can include, but are not limited to, a portable document format (PDF), a word processing document, a spreadsheet document, a JPEG image (JPEG), a portable network graphics (PNG), and a tagged image file format (TIFF).

The document classifier 145 can determine a confidence score for the document classification based on the type of the document 175. The document classifier 145 can determine a confidence score for the document classification based on the document file type. The confidence score associated with the classification can indicate a level of performance with which a machine learning model 190 outputs the classification of the type of document 175. The confidence score can indicate the document classifier's certainty that the determined classification accurately reflects the type of the document 175. The confidence score can indicate the document classifier's certainty that the determined classification accurately reflects the document file type. The document classifier 145 can implement statistical or probabilistic methods to determine the confidence score. The document classifier 145 can determine the confidence score based on factors such as the presence of specific keywords, file format characteristics, and the output of a machine learning model, among others. The confidence score can be a numerical value. The confidence score can range from 0 to 1, with 1 indicating high confidence in the classification accuracy and 0 indicating low confidence. In an aspect, the document classifier 145 can determine whether the document 175 corresponds to structured documents or unstructured documents. For structured documents, the document classifier 145 can identify patterns such as predefined templates, schemas, or data fields. For example, the document classifier 145 can use natural language processing techniques to process the text content and identify the absence of structured elements.

The document classifier 145 can determine a confidence score for each classification, indicating the classifier's certainty in determining whether the document 175 is structured or unstructured. Based on the determined confidence score, the document classifier 145 can select a data extractor. For documents 175 with high confidence scores, the document classifier 145 can cause the data extraction agent 150, via the action controller 135, to process the documents 175, or vice versa. For documents 175 with low confidence scores, the document classifier 145 can cause the AI-driven data extraction engine 155, via the action controller 135, to process the documents 175, or vice versa. In an aspect, the document classifier 145 can select a data extractor based on the classification of the document 175 as structured or unstructured. For example, for structured documents, the document classifier 145 can cause the data extraction agent 150, via the action controller 135, to process the documents. For unstructured documents, the document classifier 145 can cause the AI-driven data extraction engine 155, via the action controller 135, to process the document. The document classifier 145 can improve processing by routing documents to different data extraction engines based on the classification of the documents 175.

The document classifier 145 can determine that a confidence score associated with the classification of the document 175 is below a predefined threshold. The predefined threshold can correspond to a range of certainty values for reliable classification of the document 175. A reliable classification can refer to a classification that satisfies an accuracy level such that the selected data extraction engine processes the document 175 without causing excessive errors, inconsistencies, or misclassifications that may negatively impact downstream processing. In response to determining that the confidence score for the document 175 is below the predefined threshold, the document classifier 145, via the action controller 135, can select a plurality of data extraction engines, including the data extraction agent 150 and the AI-driven data extraction engine 155, to process the document 175 and extract data points from the document 175. The document classifier 145 can increase the likelihood of obtaining accurate results, reduce reliance on a single extraction technique, and improve robustness of data processing within the data processing system 105.

The data processing system 105 can include, interface with, communicate with, or otherwise utilize a data extraction agent 150. The data extraction agent 150 can be or include any script, file, program, application, set of instructions, or computer-executable code that can be configured to parse the structured documents 175 and extract data points. A data point can correspond to an individual unit of information parsed or derived from a document, such as a numeric value, text string, or identifier that is relevant for downstream processing. The data extraction agent 150 can implement rule-based techniques, pattern-matching techniques, or other parsing techniques, such as XML parsing, PDF parsing, and text parsing, among others. The data extraction agent 150 can parse the structured document into its constituent elements, such as words or characters. For structured documents with predefined formats (e.g., invoices, tax forms), the data extraction agent 150 can extract specific data points, such as employee name, social security number, gross pay, federal income tax withheld, and net pay, among others. In an aspect, the data extraction agent 150 can use template matching to identify and extract the data points from the structured documents. The templates can define the expected structure and location of the data points within the structured documents. The data extraction agent 150 can compare the document against the predefined templates to identify and extract relevant information. The data extraction agent 150 can implement data cleaning, normalization, and conversion tasks, among others. The data extraction agent 150 can implement validation checks to verify the accuracy or completeness of the extracted data points.

The data processing system 105 can execute a local machine learning model (such as the machine learning model 185) or a remote machine learning model (such as the machine learning model 190) to determine a confidence score that indicates the level of accuracy with which data is extracted from the document 175. The data processing system 105 can configure the extracted data points for model input by applying transformations, such as normalization, feature engineering, or vectorization. The data processing system 105 can send the preprocessed data points to the machine learning model (local or remote). Once received, the machine learning model can process the input and generate a prediction for the extracted data point, such as categorizing the data point into a specific category (e.g., gross pay, federal tax, state tax) or identifying its data type (e.g., employee name, date). For example, the machine learning model can classify the extracted value 1234.56 as a numeric data point belonging to the gross pay category. The machine learning model can generate a confidence score for each extracted data point. The confidence score can be derived from prediction probabilities. For example, the machine learning model can determine probabilities for different prediction classes, and the class with the highest probability can be selected as the predicted class for the data point. For example, if the machine learning model predicts that a data point is gross pay with a probability of 0.95 and federal tax with a probability of 0.05, the confidence score may lean towards gross pay.

The machine learning model 190 can determine or otherwise generate a confidence score associated with the classification of the document 175, where the confidence score can indicate a level of performance with which the machine learning model outputs the classification of the type of the document 175. The level of performance can refer to or include an accuracy measure associated with the machine learning model's ability to correctly classify the type of the document 175. The level of performance can be expressed in different forms, such as categorical indicators (e.g., low, medium, or high), symbolic indicators (e.g., letter grades), numerical scores on a continuous or discrete scale (e.g., 1 to 10 or 0.0 to 1.0), or probability percentages (e.g., 95% confidence). For example, a confidence score of 0.9 can correspond to a high level of performance, indicating that the classification of the document 175 as a tax form is accurate with 90% certainty. Additionally, a confidence score of 0.4 can correspond to a low level of performance, indicating reduced accuracy in the classification result.

The data processing system 105 can compare the confidence score determined or generated by the machine learning model 190 to a predefined threshold. For each extracted data point, the data processing system 105 can compare the corresponding confidence score against the predefined threshold. For example, if the confidence score satisfies or exceeds the threshold, the extracted data point can be considered accurate. If the confidence score falls below the predefined threshold, the data processing system 105 can flag the associated data points. The flagged data points can then be subjected to further review, manual verification, or alternative processing steps. Additionally, in response to determining that the confidence score for the document 175 is below the predefined threshold, the data processing system 105 can reject the processing of the document 175 and transmit a notification to a client device. The client device can include a computing device associated with an end user or a service configured to provide an updated or modified version of the document 175. For example, the data processing system 105 can transmit a message through a user-facing service, such as an application interface or a web service, to prompt submission of a modified version of the document 175.

The data processing system 105 can include, interface with, communicate with, or otherwise utilize an AI-driven data extraction engine 155. The AI-driven data extraction engine 155 can implement artificial intelligence techniques to extract data points from unstructured documents 175. The AI-drive extraction engine 155 can include various machine learning models, which can be similar to, and include any of the structure and functionality of, the machine learning model 185 or the machine learning model 190. The AI-driven data extraction engine 155 can identify patterns and extract specific data points (e.g., names, dates, addresses, quantities) from the text. The AI-driven data extraction engine 155 can convert images of text, such as scanned documents or photographs, into machine-readable text format for processing. The AI-driven data extraction engine 155 can interpret the context, syntax, or semantics of the documents 175 to identify relevant information and extract data points.

The AI-driven data extraction engine 155 can determine probabilities for different classifications for each data point extracted from unstructured documents 175. For example, the highest probability can be used as a confidence score. The AI-driven data extraction engine 155 can use language models to assess the plausibility of extracted text within the document context. For example, by identifying the semantic and syntactic coherence between the extracted text and surrounding content, the AI-driven data extraction engine 155 can generate a confidence score that reflects the likelihood of the extracted information being accurate and relevant.

The data processing system 105 can include, interface with, communicate with, or otherwise utilize a data prioritizer 160. The data prioritizer 160 can be or include any script, file, program, application, set of instructions, or computer-executable code that can be configured to prioritize the extracted data points. The data prioritizer 160 can determine priority levels for extracted data points based on the associated confidence scores. For example, data points with higher confidence scores can be given higher priorities, indicating a greater likelihood of accuracy.

The data prioritizer 160 can combine the confidence score associated with the classification of the document 175 with the confidence score associated with the extracted data point of the document 175. The data prioritizer 160 can compare the combined confidence score against a predefined threshold. For example, the document 175, classified as a PDF file with a type of tax form, can have a confidence score of 0.9, indicating high confidence in the classification. Within the document 175, the extracted data point, corresponding to total revenue, can be identified with a confidence score of 0.8, also indicating high confidence in the data extraction. The data prioritizer 160 can combine these scores. In an aspect, the data prioritizer 160 can calculate the average of both confidence scores by adding the two confidence scores and dividing it by two, which can be (0.9+0.8)/2=0.85. In another aspect, the data prioritizer 160 can use a weighted average, for example, applying weights to each confidence score based on their relative importance. For instance, if document classification is considered more important, its score can be weighted higher. In yet another aspect, the data prioritizer 160 can multiply both confidence scores to obtain a combined score (0.9×0.8=0.72). The data prioritizer 160 can compare the combined confidence score against the predefined threshold. If the combined score is greater than or equal to a predefined threshold, the data point corresponding to, for example, total revenue due on an invoice can be given a high priority for further processing. If the combined score falls below the predefined threshold, the data point can be subjected to additional quality checks or placed in a lower priority queue. The data prioritizer 160 can reduce unnecessary, wasted, and erroneous computing resource utilization by combining the document classification confidence score and the extracted data point confidence score. Such an approach can focus processing efforts on data points with a high probability of accuracy, thereby improving the efficiency and reliability of the data processing system 105.

In some cases, responsive to the selection of a plurality of data extraction engines for processing the document 175 with the confidence score below the predefined threshold, the data prioritizer 160 can aggregate the extracted data points generated by the plurality of data extraction engines to increase the overall reliability of information. For example, the data prioritizer 160 can combine the extracted data points into a consolidated set of extracted data points to be used for updating the profile data structure. The data prioritizer 160 can be configured to reduce inconsistencies between extraction engines and increase the reliability of the extracted data points prior to updating the profile data structure.

The data processing system 105 can include, interface with, communicate with, or otherwise utilize a profile manager 165. The profile manager 165 can be or include any script, file, program, application, set of instructions, or computer-executable code that can be configured to maintain profile data structures. A profile data structure can include a structured representation of an entity (e.g., user, product, or system). For example, a user profile data structure can include personal details (name, address, social security number), employment information (job title, hire date, department), compensation data (salary, bonuses), and tax details (withholdings, filing status), among other details. The profile data structures can include attributes with specific data types (e.g., name: string, salary: decimal). Each attribute can have a specific data type, such as a string, integer, date, or Boolean. The profile data structures can include relationships with other data structures. For example, a user profile data structure can reference a department profile. The profile data structures can include metadata such as creation date, modification timestamps, data source, and ownership, among others.

The profile manager 165 can assign an identifier to each profile data structure. The profile manager 165 can retrieve or update the profile data structures based on the associated identifiers. When new or updated data points are available, the profile manager 165 can identify the corresponding profile data structures based on entity identifiers or reference keys. The profile manager 165 can extract relevant attributes or metadata from the incoming data points. The profile manager 165 can identify entity identifiers or reference keys embedded within the data point. The profile manager 165 can maintain an index structure that maps entity identifiers to corresponding profile data structures. Upon receiving a new data point, the profile manager 165 can query the index using the extracted identifier to identify the target profile data structure. The profile manager 165 can implement a hash table, where the entity identifier can be hashed to generate a key. The profile manager 165 can use the key to access the corresponding profile data structure.

The profile manager 165 can update the profile data structure by aggregating and incorporating prioritized extracted data points. For example, when processing payroll data, the profile manager can aggregate salary information for each employee. The prioritized data points, such as salary adjustments or new deductions, can be given priority during the aggregation process. The profile manager can identify the corresponding profile within the profile data structure and update the salary attribute. In some cases, the profile manager 165 can update the profile data structure using the consolidated set of extracted data points generated by the data prioritizer 160, where the consolidated set can include aggregated outputs from a plurality of data extraction engines. Such a configuration can improve the accuracy of payroll-related updates and reduce errors caused by any extraction engine.

The data processing system 105 can include, interface with, communicate with, or otherwise utilize a payroll processing system 170. The payroll processing system 170 can be or include any script, file, program, application, set of instructions, or computer-executable code that can be configured to execute payroll-related operations based on profile data structures. The data processing system 105 can input updated profile data structures into the payroll processing system 170 and cause the payroll processing system 170, via the action controller 135, to execute operations in accordance with the updated profile data structures. For example, the payroll data processing system 170 can calculate federal, state, and local taxes based on the updated profile data structures that include employee earnings, tax rates, and exemptions, among others. The payroll data processing system 170 can calculate various deductions such as health insurance, retirement contributions, and loan repayments. The payroll data processing system 170 can determine the amount payable to the employee after all deductions and taxes have been applied. The payroll data processing system 170 can generate paystubs, including earnings, deductions, and net pay for each employee, using the updated profile data structures. The payroll data processing system 170 can generate summary reports of payroll data, including tax summaries and employee earnings reports. The payroll data processing system 170 can generate tax-related forms, such as W-2 forms. The payroll data processing system 170 can initiate electronic transfers of employee net pay to designated bank accounts.

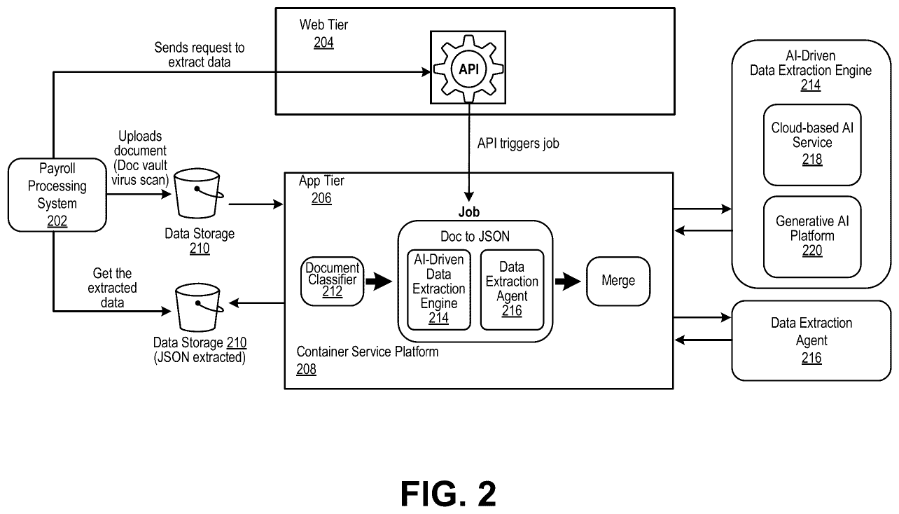

FIG. 2 depicts an example operation of a system according to one or more aspects of the technical solutions described herein. As illustrated by way of example in FIG. 2, a system 200 can include a payroll system 202, a web tier 204, and an application (“app”) tier 206. The app tier 206 can be hosted within a container service platform 208. Various components of the system 200 shown in FIG. 2 may be similar to, and include any of the structure and functionality of, the system 100 of FIG. 1. For example, the payroll processing system 202 shown in FIG. 2 can include one or more components or functionalities of the payroll processing system 170 depicted in FIG. 1. The data storage 210 shown in FIG. 2 can include one or more components or functionalities of the database 120 depicted in FIG. 1. In an aspect, the data storage 210 can be a component of a cloud-based storage service provider. The document classifier 212 shown in FIG. 2 can include one or more components or functionalities of the document classifier 145 depicted in FIG. 1. The AI-driven data extraction engine 214 shown in FIG. 2 can include one or more components or functionalities of the AI-driven data extraction engine 155 depicted in FIG. 1. The data extraction agent 216 shown in FIG. 2 can include one or more components or functionalities of the data extraction agent 150 depicted in FIG. 1.

The web tier 204 can be a user interface layer within a multi-tier architecture. The web tier 204 can facilitate interaction between users and the system. The web tier 204 can manage user interface elements, communication protocols, and data exchange, among others. The web tier can display information and collect input through web browsers using technologies such as HTML, CSS, or JavaScript to render web pages. The web tier 204 can facilitate the interaction between the user and the application through web pages rendered in a browser. The web tier 204 can generate content based on user requests. For example, when a user logs into a website, the web tier 204 can generate the corresponding web pages and content to display based on the user's profile and permissions. The web tier 204 can make API calls to communicate with the app tier 206, for example, to send user requests to the app tier 206 and present the processed data to the user in a user-friendly format.

The app tier 206, also referred to as the logic tier within a multi-tier architecture, can manage the processing of the application, including business rules, calculations, and data manipulation, among others. The app tier 206 can function as an intermediary between the web tier 204 and the payroll processing system 202. The app tier 206 can process user requests and manage data flow between the web tier 204 and the backend. The app tier 206 can leverage server-side languages and frameworks for implementing the business logic and managing data transactions within the application. The app tier 206 can perform data validation, transformation, and integration, among others.

The app tier 206 can be hosted, run, or otherwise executed or maintained within the container service platform 208, a cloud-based environment that provides the tools and infrastructure to deploy, manage, and scale containerized applications. The container service platform 208 can include packaging an application and its dependencies into a container such that the application can run consistently across different environments. The container service platform 208 can automate the deployment, scaling, and management of containerized applications. The container service platform 208 can allow containers to run on any environment that supports the container runtime.

Users or administrators can upload documents (e.g., structured and unstructured) to the data storage 210 via the payroll processing system 202. The data storage 210 can provide scalability to accommodate growing document volumes. The payroll processing system 202 can implement security measures, including version control, access control, and encryption. Upon document upload, the payroll processing system 202 can trigger a document processing pipeline by sending an API call (e.g., REST API) to the web tier 204. The API request can include metadata about the uploaded document, such as file name, size, upload time, and document type, among others. The web tier 204 can transmit the request to the app tier 206, initiating the document processing workflow.

The app tier 206 can retrieve the uploaded documents from the data storage 210 for subsequent processing. The app tier 206 can perform validation checks on the document format, size, and content, among others. The app tier 206 can execute the document classifier 212, which uses a combination of document type, file type, and content analysis to categorize documents and determine a category for each document. The document classifier 212 can determine a confidence score, indicated as a probability value between 0 and 1, for each classification. The confidence score can quantify the classifier's certainty in the determined category. Based on the calculated confidence score, the document classifier 212 can select an appropriate data extraction engine. For documents with high confidence scores, for example, indicative of a structured format, the document classifier 212 can implement the data extraction agent 216 configured for structured data.

For documents with low confidence scores (e.g., below a threshold), for example, associated with unstructured format, the document classifier 212 can implement the AI-driven data extraction engine 214 to manage the complexity and ambiguity inherent in unstructured data. The AI-driven data extraction engine 214 can include a cloud-based AI service 218 or a generative AI platform 220. The cloud-based AI service 218 can provide artificial intelligence capabilities and resources to manage document processing and text extraction. The cloud-based AI service 218 can identify and extract data from the documents. The cloud-based AI service 218 can provide a range of functionalities, including natural language processing, image recognition, machine learning, optical character recognition, and predictive analytics, among others. The generative AI platform 220 can use AI models to extract and classify text from diverse document types. The generative AI platform 220 can provide customized AI models for specific document processing tasks.

The AI-driven data extraction engine 214 and the data extraction agent 216 can extract data points from the classified document and transform the extracted data points into a structured format (e.g., JSON, CSV). The data extraction agent 216 can determine a confidence score for extracted data points using a machine learning model. The confidence score can indicate a level of accuracy with which data is extracted from the classified document. The AI-driven data extraction engine 214 can determine a confidence score for extracted data points.

The app tier 206 can prioritize the order in which extracted data points are merged into the profile data structure based on a combined confidence score calculated from the confidence associated with both the document classification and the individual data point. For example, the app tier 206 can establish a predefined threshold to differentiate between high priority data points and low priority data points. The app tier 206 can store the processed data, including extracted data points and metadata, in the data storage 210 for further processing. The payroll processing system can retrieve the processed data from the data storage 210 to perform payroll calculations and generate outputs.

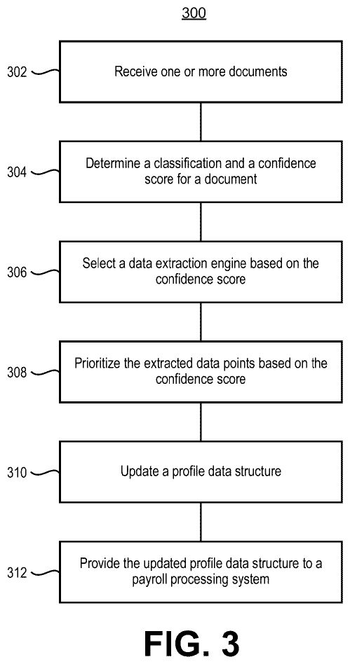

FIG. 3 depicts a method 300 of operation execution with automatically updated profile data structures using machine learning. The method 300 can be implemented using one or more systems or components depicted in FIGS. 1-2 or FIG. 4. The method can include operations 302-312. The operations 302-312 can be executed in any order or sequence.

At 302, the method 300 can include receiving one or more documents. The method can include receiving the one or more documents in a batch upload. The batch upload can be received or provided responsive to a condition or event. The batch upload can be received based on a time interval or periodically, such as every 1 hour, 2 hours, 6 hours, 12 hours, 24 hours, 48 hours, 72 hours, 1 week, 2 weeks, monthly, or other time interval. The batch upload can be received or fetched responsive to a request from a component or system depicted in FIG. 1 or FIG. 2.

At 304, the method 300 can include determining a classification and a confidence score for a document. The method can include determining a classification and a confidence score for the document using a machine learning model trained on a dataset of predefined categories maintained in a database. The dataset of predefined categories can include a plurality of field-value pairs. Each field-value pair can correspond to an attribute associated with training the machine learning model. The confidence score can indicate a level of performance with which the machine learning model outputs the classification of a type of the document. The type of the document can include at least one of a report, a tax form, a hand-written note, a hand-written number, an invoice, a receipt, a contract, or an email. The method can include classifying the document based on a document file type. The document file type can include at least one of a portable document format, a word processing document, a spreadsheet document, a photographic experts group image, a portable network graphics image, or a tagged image file format image.

At 306, the method 300 can include selecting a data extraction engine based on the confidence score. The data extraction engine can extract data points from the document. The method can include determining, via the machine learning model, the confidence score for indicating a level of accuracy with which data is extracted from the document. In instances where the confidence score associated with the classification of the document is below a predefined threshold, the method can include selecting a plurality of data extraction engines to extract data points from the document. The method can also include, responsive to the confidence score being below the predefined threshold, rejecting processing of the document and transmitting a notification to a client device to cause the client device to provide a modified version of the document.

At 308, the method 300 can include prioritizing the extracted data points based on the confidence score. The method can include prioritizing the extracted data points based on the confidence score associated with the document. The method can include prioritizing the extracted data point based on a combination of the confidence score associated with the classification of the document and the confidence score associated with the extracted data point, and a determination that the combined confidence score satisfies a predefined threshold. The method can include, responsive to the selection of a plurality of data extraction engines, aggregating the extracted data points from the plurality of data extraction engines to generate a set of extracted data points to be used for updating the profile data structure.

At 310, the method 300 can include updating a profile data structure. The method can include updating the profile data structure in response to aggregating the prioritized extracted data points.

At 312, the method 300 can include providing the updated profile data structure to a payroll processing system. The method can include providing the updated profile data structure to the payroll processing system to cause the payroll processing system to execute one or more operations in accordance with the updated profile data structure.

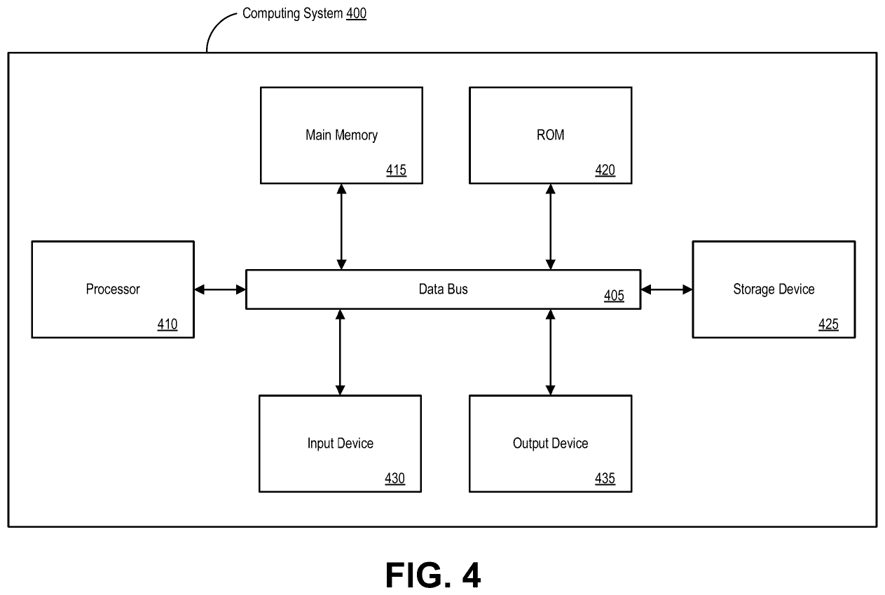

FIG. 4 depicts a block diagram of a computing system 400 for implementing the embodiments of the technical solutions discussed herein, in accordance with various aspects. FIG. 4 illustrates a block diagram of an example computing system 400, which can also be referred to as the computer system 400. Computing system 400 can be used to implement elements of the systems and methods described and illustrated herein. Computing system 400 can be included in and run any device (e.g., a server, a computer, a cloud computing environment, or a data processing system).

Computing system 400 can include at least one bus data bus 405 or other communication device, structure or component for communicating information or data. Computing system 400 can include at least one processor 410 or processing circuit coupled to the data bus 405 for executing instructions or processing data or information. Computing system 400 can include one or more processors 410 or processing circuits coupled to the data bus 405 for exchanging or processing data or information along with other computing systems 400. Computing system 400 can include one or more main memories 415, such as a random access memory (RAM), dynamic RAM (DRAM), cache memory or other dynamic storage device, which can be coupled to the data bus 405 for storing information, data, and instructions to be executed by the processor(s) 410. Main memory 415 can be used for storing information (e.g., data, computer code, commands or instructions) during execution of instructions by the processor(s) 410.

Computing system 400 can include one or more read only memories (ROMs) 420 or other static storage device 425 coupled to the bus 405 for storing static information and instructions for the processor(s) 410. Storage devices 425 can include any storage device, such as a solid-state device, magnetic disk or optical disk, which can be coupled to the data bus 405 to persistently store information and instructions.

Computing system 400 can be coupled via the data bus 405 to one or more output devices 435, such as speakers or displays (e.g., liquid crystal display or active matrix display) for displaying or providing information to a user. Input devices 430, such as keyboards, touch screens or voice interfaces, can be coupled to the data bus 405 for communicating information and commands to the processor(s) 410. Input device 430 can include, for example, a touch screen display (e.g., output device 435). Input device 430 can include a cursor control, such as a mouse, a trackball, or cursor direction keys, for communicating direction information and command selections to the processor(s) 410 for controlling cursor movement on a display.

The processes, systems and methods described herein can be implemented by the computing system 400 in response to the processor 410 executing an arrangement of instructions contained in main memory 415. Such instructions can be read into main memory 415 from another computer-readable medium, such as the storage device 425. Execution of the arrangement of instructions contained in main memory 415 causes the computing system 400 to perform the illustrative processes described herein. One or more processors 410 in a multi-processing arrangement can also be employed to execute the instructions contained in main memory 415. Hard-wired circuitry can be used in place of or in combination with software instructions together with the systems and methods described herein. Systems and methods described herein are not limited to any specific combination of hardware circuitry and software.

Although an example computing system has been described in FIG. 4, the subject matter, including the operations described in this specification, can be implemented in other types of digital electronic circuitry, or in computer software, firmware, or hardware, including the structures described in this specification and their structural equivalents, or in combinations of one or more of them.

The foregoing examples have been provided merely for the purpose of explanation and are in no way to be construed as limiting of the technical solutions described in this application. While aspects of the technical solutions described in this application have been described with reference to an exemplary embodiment, it is understood that the words that have been used herein are words of description and illustration, rather than words of limitation. Changes can be made, within the purview of the appended claims, as presently stated and as amended, without departing from the scope and spirit of the technical solutions described in this application. Although aspects of the technical solutions described in this application have been described herein with reference to particular means, materials, and embodiments, the technical solutions described in this application are not intended to be limited to the particulars disclosed herein; rather, the technical solutions described in this application extend to all functionally equivalent structures, methods, and uses, such as are within the scope of the appended claims.

The subject matter and the operations described in this specification can be implemented in digital electronic circuitry, or in computer software, firmware, or hardware, including the structures described in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device,” “component” or “data processing apparatus” or the like encompass various apparatuses, devices, and machines for processing data, including, by way of example, a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including, by way of example, semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently described systems or methods, their components, acts, or elements to single or plural configurations. References to any act or element being based on any information, act or element can include implementations where the act or element is based at least in part on any information, act, or element.

Any implementation described herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations described herein.

References to “or” can be construed as inclusive so that any terms described using “or” can indicate any of a single, more than one, and all of the described terms. References to at least one of a conjunctive list of terms can be construed as an inclusive OR to indicate any of a single, more than one, and all of the described terms. For example, a reference to “at least one of ‘A’ and ‘B’”′ can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts, such as substitutions, changes, and omissions, can be made in the design, operating conditions, and arrangement of the described elements and operations without departing from the scope of the technical solutions described herein.

What is claimed is:

1. A system for operation execution with automatically updated profile data structures using machine learning, the system comprising:
one or more processors, coupled with memory, to:
determine, using a machine learning model trained on a dataset of predefined categories maintained in a database, for a document:
a classification of a type of the document; and
a confidence score associated with the classification, the confidence score indicating a level of performance with which the machine learning model outputs the classification of the type of the document;
select, for the document, a data extraction engine based on the confidence score, the data extraction engine configured to extract data points from the document;
prioritize the extracted data points based on the confidence score associated with the document;
update a profile data structure in response to aggregating the prioritized extracted data points; and
input the profile data structure into a payroll processing system to cause the payroll processing system to execute one or more operations in accordance with the updated profile data structure.

2. The system of claim 1, wherein the one or more processors further:
receive the document in a batch upload.

3. The system of claim 1, wherein the one or more processors further:
classify the document based on a document file type.

4. The system of claim 3, wherein the document file type comprises at least one of a portable document format, a word processing document, a spreadsheet document, a photographic experts group image, a portable network graphics image, or a tagged image file format image.

5. The system of claim 1, wherein the type of the document comprises at least one of a report, a tax form, a hand-written note, a hand-written number, an invoice, a receipt, a contract, or an email.

6. The system of claim 1, wherein the one or more processors further:
determine, via the machine learning model, the confidence score for indicating a level of accuracy with which data is extracted from the document.

7. The system of claim 1, wherein the one or more processors are configured to prioritize the extracted data point based on:
a combination of the confidence score associated with the classification of the document and the confidence score associated with the extracted data point; and
a determination that the combined confidence score satisfies a predefined threshold.

8. The system of claim 1, wherein the dataset of predefined categories comprises a plurality of field-value pairs, each field-value pair corresponding to an attribute associated with training the machine learning model.

9. The system of claim 1, wherein the one or more processors further:
determine that a confidence score associated with the classification of a second document is below a predefined threshold; and
select, responsive to determining that the confidence score is below the predefined threshold, a plurality of data extraction engines to extract data points from the second document.

10. The system of claim 9, wherein the one or more processors further:
aggregate the extracted data points from the plurality of data extraction engines to generate a set of extracted data points to be used for updating the profile data structure.

11. The system of claim 1, wherein the one or more processors further:
determine that a confidence score associated with the classification of a second document is below a predefined threshold;
reject, responsive to determining that the confidence score is below the predefined threshold, processing of the second document; and
transmit a notification to a client device to cause the client device to provide a modified version of the second document.

12. A method of operation execution with automatically updated profile data structures using machine learning, the method comprising:
determining, using a machine learning model trained on a dataset of predefined categories maintained in a database, for a document:
a classification of a type of the document; and
a confidence score associated with the classification, the confidence score indicating a level of performance with which the machine learning model outputs the classification of the type of the document;
selecting, for the document, a data extraction engine based on the confidence score, the data extraction engine configured to extract data points from the document;
prioritizing the extracted data points based on the confidence score associated with the document;
updating a profile data structure in response to aggregating the prioritized extracted data points; and
providing the updated profile data structure to a payroll processing system to cause the payroll processing system to execute one or more operations in accordance with the updated profile data structure.

13. The method of claim 12, further comprising:
receiving the document in a batch upload.

14. The method of claim 12, further comprising:
classifying the document based on a document file type.

15. The method of claim 14, wherein the document file type comprises at least one of a portable document format, a word processing document, a spreadsheet document, a photographic experts group image, a portable network graphics image, or a tagged image file format image.

16. The method of claim 12, wherein the type of the document comprises at least one of a report, a tax form, a hand-written note, a hand-written number, an invoice, a receipt, a contract, or an email.

17. The method of claim 12, further comprising:
determining, via the machine learning model, the confidence score for indicating a level of accuracy with which data is extracted from the document.

18. The method of claim 12, further comprising:
prioritizing the extracted data point based on:
a combination of the confidence score associated with the classification of the document and the confidence score associated with the extracted data point; and
a determination that the combined confidence score satisfies a predefined threshold.

19. The method of claim 12, wherein the dataset of predefined categories comprises a plurality of field-value pairs, each field-value pair corresponding to an attribute associated with training the machine learning model.

20. A non-transitory computer readable medium including one or more instructions stored thereon and executable by a processor to:
determine, by a processor, using a machine learning model trained on a dataset of predefined categories maintained in a database, for a document:
a classification of a type of the document; and
a confidence score associated with the classification, the confidence score indicating a level of performance with which the machine learning model outputs the classification of the type of the document;
select, by the processor, for the document, a data extraction engine based on the confidence score, the data extraction engine configured to extract data points from the document;
prioritize, by the processor, the extracted data points based on the confidence score associated with the document;
update, by the processor, a profile data structure in response to aggregating the prioritized extracted data points; and
input, by the processor, the profile data structure into a payroll processing system to cause the payroll processing system to execute one or more operations in accordance with the updated profile data structure.
